(19) United States
(12) Patent Application Publication
(10) Pub. No.: US 2024/0360987 A1
(43) Pub. Date: Oct. 31, 2024

(54) WICK STRUCTURE

(71) Applicant: DONGLIN HE, Zhumadian (CN)

(72) Inventor: DONGLIN HE, Zhumadian (CN)

(21) Appl. No.: 17/803,192

(22) Filed: Apr. 28, 2023

(51) Int. Cl. F21V 19/06; F21V 23/00; F21V 23/02; F21Y 103/30

(52) U.S. Cl. CPC F21V 19/06; F21V 23/002; F21V 23/02; F21Y 2103/30

(57) ABSTRACT

The present application relates to the technical field of wick structures, in particular to a novel wick structure. Its technical solution includes: a novel wick structure, comprising a base, a housing, an upper cover and a lower cover, the upper cover and the lower cover are arranged inside the base, a mounting frame is arranged on the upper cover and the lower cover, a conductive strip is arranged on top end of the mounting frame, resistors are embedded inside the upper cover and lower cover, a wick is arranged between the conductive strip and the resistor, the housing is arranged on the base to cover outer sides of the upper cover, the wick and the lower cover. The present application has a simple structure and is convenient for rapid assembly, thereby reducing the difficulty of assembly and ensuring the qualified rate of products.

### TECHNICAL FIELD

The present application relates to the technical field of wick structures, in particular to a novel wick structure.

### BACKGROUND

The integrated structure of the wick refers to a structure in which the wick and the lamp housing are integrally manufactured. The lamp wick and the lamp housing of this structure are made of the same material and processed through an integral molding process. Compared with the traditional lamp structure, the wick integrated structure has the following advantages: Excellent heat dissipation: PVC and other materials are used to make the lamp housing and lamp holder, which can ensure that the heat dissipation effect of the lamp is better when the lamp is illuminated for a long time, and the damage rate of the lamp is reduced; Longer service life: Lamps with integrated wick can avoid problems such as poor contact between the wick and the lamp housing or improper maintenance, thereby prolonging the service life of the lamp; Better effect: Since the wick and the lamp housing are integrated, the coordination between the two can be better considered in the design, so that the lighting effect of the lamp is more uniform and soft; Higher safety: There is no gap between the housing and the lamp holder of the wick integrated structure lamp, which can avoid unsafe hidden dangers, such as electric leakage. In the prior art, the lamp sets are processed and welded separately, but due to the structure of the plastic parts, it is difficult to assemble the resistance when it is assembled to the structural parts, and the defect rate is high.

### SUMMARY

The present application provides a novel wick structure, which solves the above-mentioned technical problems.

The technical solution that the present application provided for solving the above-mentioned technical problems is as follows: a novel wick structure, comprising a base, a housing, an upper cover and a lower cover, the upper cover and the lower cover are arranged inside the base, a mounting frame is arranged on the upper cover and the lower cover, a conductive strip is arranged on top end of the mounting frame, resistors are embedded inside the upper cover and lower cover, a wick is arranged between the conductive strip and the resistor, the housing is arranged on the base to cover outer sides of the upper cover, the wick and the lower cover.

The beneficial effect of the present application is: when in use, the user forms the upper cover and the lower cover through the injection molding process, and then the user places the resistors between the upper cover and the lower cover, and clamps and fixes the resistors through the upper cover and the lower cover, and then the user welds and fixes the wicks with the conductive strip and the resistors, and then fixes the upper cover and the lower cover to the base through buckles, and then connects and fixes the housing to the base through rivets.

On the basis of the above technical solution, the following improvements can also be made to the present application.

Further, two wicks are provided, and the two wicks are symmetrically distributed on both sides of the mounting frame.

The beneficial effect of using the above further solution is that: the brightness of the lamp bulb is increased by two wicks, and when one wick fails, the other can work normally.

Further, limiting grooves are arranged in the upper cover and the lower cover, and the resistors are arranged in the upper cover and the lower cover in a position-limited manner through the limiting grooves.

The beneficial effect of using the above further solution is that: it is convenient to limit the mounting position of the resistors.

Further, the wicks are electrically connected to the base through the resistors.

The beneficial effect of using the above further solution is that: it is convenient to connect the wick with the power supply through the base.

Further, after the conductive strip is formed by stamping, it is placed in a mold and integrally formed by injection molding with the upper cover or the lower cover.

The beneficial effect of using the above further solution is that: it is convenient for subsequent assembly, thereby increasing the assembly efficiency of the lamp bulb.

The above description is only an overview of the technical solution of the present application. In order to have a clearer understanding of the technical means of the present application and implement them according to the contents of the description, the preferred embodiments of the present application and accompanying drawings are described in detail below. The specific implementation manner of the present application is given in detail by the following examples and accompanying drawings.

### BRIEF DESCRIPTION OF DRAWINGS

The accompanying drawings described herein are used to provide a further understanding of the application and constitute a part of the application. The exemplary embodiments and descriptions of the present application are used to explain the present application, and do not constitute undue limitation to the present application.

In figures:

FIG. 1 is a schematic diagram of the front view of the present application;

FIG. 2 is a schematic diagram of the internal structure of the present application;

FIG. 3 is a schematic diagram of a half-section structure of the present application.

In the Figures, the list of parts represented by each label is as follows:
1. Base; 2. Housing; 3. Upper cover; 4. Conductive strip; 5. Mounting frame; 6. Wick; 7. Lower cover; 8. Resistor.

### DETAILED DESCRIPTION

The principles and features of the application are described below in conjunction with the accompanying drawings. The examples given are only used to explain the application, and are not intended to limit the scope of the application. In the following paragraphs, the present application is described more particularly by way of example with reference to the accompanying drawings. The advantages and features of the present application will become more apparent from the following description and claims. It should be noted that the drawings are all in very simplified form and use imprecise scales, and are only used to facilitate and clearly assist the purpose of illustrating the embodiments of the present application.

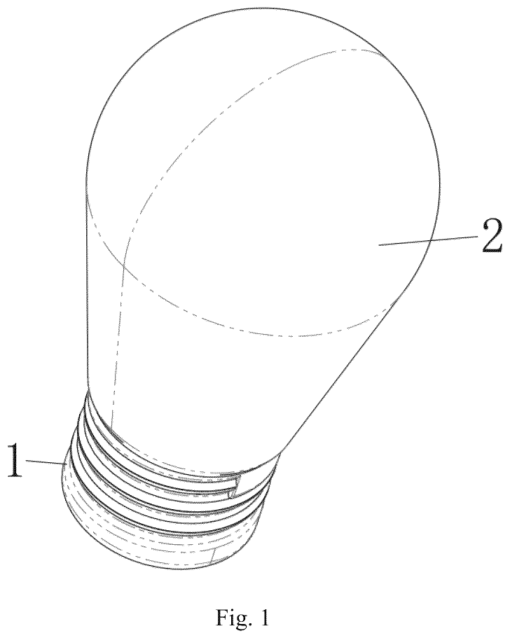

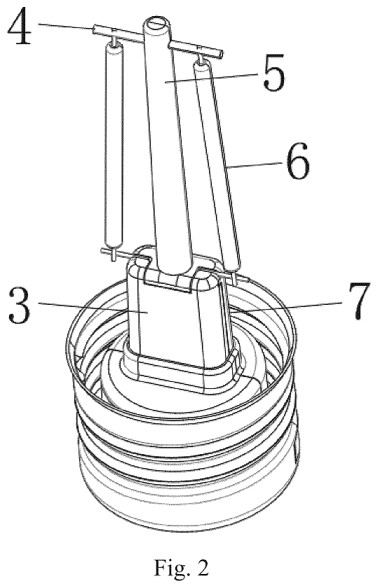

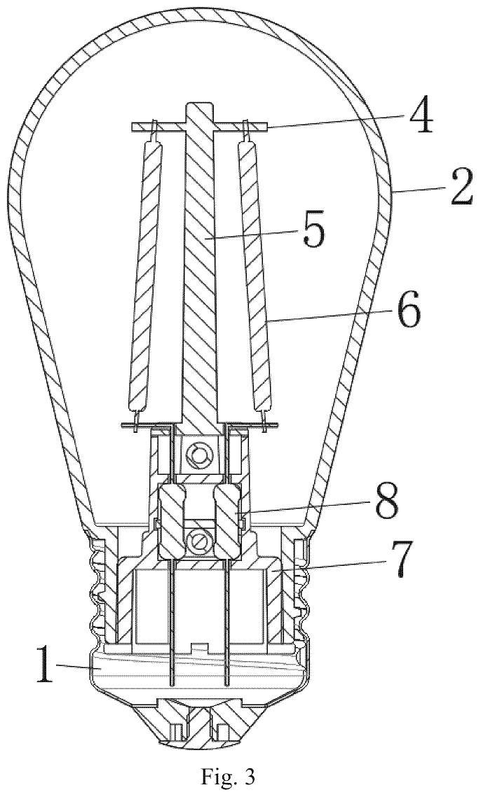

Please refer to FIG. 1 to FIG. 3, the embodiment that this application provides:

### Embodiment 1

A novel wick structure comprises a base 1, a housing 2, an upper cover 3 and a lower cover 7, the upper cover 3 and the lower cover 7 are arranged inside the base 1, a mounting frame 5 is arranged on the upper cover 3 and the lower cover 7, a conductive strip 4 is arranged on top end of the mounting frame 5. After the conductive strip 4 is formed by stamping, it is placed in a mold and integrally formed by injection molding with the upper cover 3 or the lower cover 7. Resistors 8 are embedded inside the upper cover 3 and the lower cover 7. The user forms the upper cover 3 and the lower cover 7 through the injection molding process, and then the user places the resistors 8 between the upper cover 3 and the lower cover 7, and clamps and fixes the resistors 8 through the upper cover 3 and the lower cover 7, and then the user welds and fixes the wicks 6 with the conductive strip 4 and the resistors 8, and then fixes the upper cover 3 and the lower cover 7 to the base 1 through buckles, and then connects and fixes the housing 2 to the base 1 through rivets.

Limiting grooves are arranged in the upper cover 3 and the lower cover 7, and the bottom of the upper cover 3 and the lower cover 7 is provided with a groove to prevent the positive and negative electrodes from being twisted together when the base 1 and the outer shell 2 are rotated and fixed to cause a short circuit. Holes are provided on the bottom of the base 1, and after the pin of the resistor 8 is penetrated into the hole of the base 1, the rivet is embedded to realize the energization and lighting of the wick 6. The resistors 8 are arranged in the upper cover 3 and the lower cover 7 in a position-limited manner through the limiting grooves. Wicks 6 are arranged between the conductive strip 4 and the resistor 8, wherein two wicks 6 are provided, and the two wicks 6 are symmetrically distributed on both sides of the mounting frame 5. The housing 2 is arranged on the base 1 to cover outer sides of the upper cover 3, the wicks 6 and the lower cover 7, wherein the wicks 6 are electrically connected to the base 1 through the resistors 8.

When using the novel wick structure based on Embodiment 1: The user forms the upper cover 3 and the lower cover 7 through the injection molding process, and then the user places the resistors 8 between the upper cover 3 and the lower cover 7, and clamps and fixes the resistors 8 through the upper cover 3 and the lower cover 7, and then the user welds and fixes the wicks 6 with the conductive strip 4 and the resistors 8, and then fixes the upper cover 3 and the lower cover 7 to the base 1 through buckles, and then connects and fixes the housing 2 to the base 1 through rivets.

The above is only a preferred embodiment of the application, and does not limit the application in any form. Those skilled in the art can smoothly implement the application as shown in the accompanying drawings and the above description; However, any equivalent changes, modifications and evolutions made by those skilled in the art without departing from the scope of the technical solutions of the present application by using the technical content disclosed above are equivalent embodiments of the present application. At the same time, any amendment, modification and evolution of any equivalent changes made to the above embodiments based on the substantive technology of the present application still fall within the protection scope of the technical solution of the present application.

What is claimed is:

1. A wick structure, comprising a base (1), a housing (2), an upper cover (3) and a lower cover (7), the upper cover (3) and the lower cover (7) are arranged inside the base (1), a mounting frame (5) is arranged on the upper cover (3) and the lower cover (7), a conductive strip (4) is arranged on top end of the mounting frame (5), resistors (8) are embedded inside the upper cover (3) and the lower cover (7), wicks (6) are arranged between the conductive strip (4) and the resistor (8), the housing (2) is arranged on the base (1) to cover outer sides of the upper cover (3), the wicks (6) and the lower cover (7).

2. The wick structure according to claim 1, wherein two wicks (6) are provided, and the two wicks (6) are symmetrically distributed on both sides of the mounting frame (5).

3. The wick structure according to claim 1, wherein limiting grooves are arranged in the upper cover (3) and the lower cover (7), and the resistors (8) are arranged in the upper cover (3) and the lower cover (7) in a position-limited manner through the limiting grooves.

4. The wick structure according to claim 1, wherein the wicks (6) are electrically connected to the base (1) through the resistors (8).

5. The wick structure according to claim 1, wherein after the conductive strip (4) is formed by stamping, it is placed in a mold and integrally formed by injection molding with the upper cover (3) or the lower cover (7).
